(19) United States
(12) Patent Application Publication
(10) Pub. No.: US 2015/0138821 A1
(43) Pub. Date: May 21, 2015

(54) RESIN OPTICAL MEMBER AND AUTOMOTIVE LAMP

(71) Applicant: KOITO MANUFACTURING CO., LTD., Minato-ku (JP)

(72) Inventors: Mamoru KOSUGE, Shizuoka-shi (JP); Noriko Fukawa, Shizuoka-shi (JP); Masashi Katayama, Shizuoka-shi (JP); Takahito Osawa, Shizuoka-shi (JP); Yuji Saito, Gamagori-city (JP); Hirohisa Kato, Gamagori-city (JP); Takehiro Shimizu, Gamagori-city (JP); Norihito Soma, Toyokawa-city (JP)

(73) Assignee: KOITO MANUFACTURING CO., LTD., Minato-ku (JP)

(21) Appl. No.: 14/607,568

(22) Filed: Jan. 28, 2015

Related U.S. Application Data
(63) Continuation of application No. PCT/JP2013/004384, filed on Jul. 18, 2013.

(30) Foreign Application Priority Data
Aug. 2, 2012 (JP) 2012-172345

(51) Int. Cl. F21S 8/10; F21V 5/00

(52) U.S. Cl. CPC F21S 48/2212; F21S 48/2237; F21V 5/005
USPC 362/511; 428/156; 362/522; 362/355

(57) ABSTRACT

A resin optical member allows light to pass therethrough. The resin optical member includes a fine asperity portion formed with fine asperity structure and a flat portion not formed with fine asperity structure. The fine asperity structure include concavities or convexities formed at a pitch equal to or less than a wavelength of visible light. The fine asperity structure includes concavities or convexities having a height 37 nm or more.

### BACKGROUND OF THE INVENTION

1. Field of the Invention

The present invention relates to a resin optical member and an automotive lamp in which a resin optical member is used.

2. Description of the Related Art

Automotive lamps in which a resin optical member such as a resin lens and a resin light guide are known. For example, there are known clearance lamps mounted on an automotive headlamp or tail lamps provided toward the back of a vehicle in which an LED is provided at an end of a rod-shaped resin light guide so that a line of light is obtained (see, for example, patent document 1).

[patent document 1] JP2009-146722

Recently, an automotive lamp is required to provide an appearance of novel design unlike that of the related art in addition to providing proper performance.

### SUMMARY OF THE INVENTION

The present invention addresses such requirements and a purpose thereof is to provide a resin optical member presenting an appearance of novel design and an automotive lamp in which such a member is used.

To address the aforementioned issue, the resin optical member according to an embodiment of the present invention allows light to pass therethrough and includes a first portion formed with fine asperity structure and a second portion not formed with fine asperity structure.

The fine asperity structure may include concavities or convexities formed at a pitch equal to or less than a wavelength of visible light. The fine asperity structure may include concavities or convexities having a height 37 nm or more.

Another embodiment of the present invention relates to an automotive lamp. The automotive lamp includes a light source mount for mounting a light source and a resin optical member that controls light from the light source and directs the light forward. The resin optical member includes a first portion formed with fine asperity structure and a second portion not formed with fine asperity structure. The resin optical member may be a front cover, a projection lens, an inner lens, or a light guide.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a resin optical member according to an embodiment of the present invention;

FIG. 2 illustrates the action of the resin optical member according to the embodiment;

FIGS. 3A-3E show atomic force microscopic (AFM) images of the incident surface of the resin optical member;

FIG. 4 shows results of experiments to determine whether a viewer can recognize the difference between the flat portion and the fine asperity portion;

FIG. 5 shows conditions in which the experiments were conducted;

FIG. 6 shows a resin optical member according to another embodiment of the present invention;

FIG. 7 shows a resin optical member according to still another embodiment of the present invention;

FIG. 8 is a schematic horizontal cross sectional view of an automotive lamp according to the first exemplary embodiment;

FIG. 9 shows a part of the side of inner lens;

FIG. 10 is a schematic horizontal cross sectional view of an automotive lamp according to the second exemplary embodiment;

FIG. 11 is a schematic horizontal cross sectional view of an automotive lamp according to the third exemplary embodiment;

FIG. 12 is a schematic vertical cross sectional view of an automotive lamp according to the fourth exemplary embodiment;

FIG. 13 is an exploded front view of an automotive lamp according to the fifth exemplary embodiment;

FIG. 14 is a cross sectional view along I-I in FIG. 13 of the inner lens including the LED;

FIGS. 15A and 15B show an automotive lamp according to the sixth exemplary embodiment of the present invention;

FIG. 16 shows an automotive lamp according to the seventh exemplary embodiment; and

FIGS. 17A and 17B show an automotive lamp according to the eight exemplary embodiment.

### DETAILED DESCRIPTION OF THE INVENTION

The invention will now be described by reference to the preferred embodiments. This does not intend to limit the scope of the present invention, but to exemplify the invention.

A detailed description will be given of embodiments of the present invention with reference to the drawings.

FIG. 1 shows a resin optical member 10 according to an embodiment of the present invention. The resin optical member 10 shown in FIG. 1 is used as an inner lens or a front cover of an automotive lamp.

FIG. 1 depicts the resin optical member 10 of a flat plate shape for brevity. However, the shape of the resin optical member is not limited to that of the illustration. The resin optical member 10 may be of any of various shapes depending on the shape of the automotive lamp in which the resin optical member 10 is built. The resin optical member 10 may be formed of a resin such as acryl or polycarbonate that is transparent to visible light.

As shown in FIG. 1, the resin optical member 10 is provided with an incident surface 12 on which light from a light source is incident and an exit surface 14 from which light exits. According to the embodiment, the incident surface 12 and the exit surface 14 are planar. However, the shape of the incident surface 12 and the exit surface 14 is not limited to that of the embodiment. For example, the surfaces may be curved.

The incident surface 12 of the resin optical member 10 according to the embodiment includes a fine asperity portion 16 formed with fine asperity structure 20 and a flat portion 18 not formed with fine asperity structure. The fine asperity structure 20 form a nano-pattern including convexities or concavities formed at a pitch P equal to or less than a wavelength of visible light (380 nm-780 nm). FIG. 1 depicts the fine asperity structure 20 as triangles for brevity. However, the shape of the fine asperity structure 20 is not limited to that of the illustration. The term “flat” merely means lack of asperities on a microscopic scale, i.e., lack of nano-order asperities. Macroscopically, the flat portion may be curved.

FIG. 1 depicts the pitch P of concavities or convexities as being constant, but concavities or convexities may be located on the fine asperity portion 16 at various pitches. More specifically, the requirement for the fine asperity structure 20 is that they include concavities or convexities at a pitch equal to or less than the upper limit of a wavelength of visible light (i.e., 780 nm or less). Concavities or convexities at a pitch equal to or more than a wavelength of visible light (i.e., exceeding 780 nm) may coexist additionally. For example, the fine asperity structure 20 may be formed of concavities or convexities at pitches varying from 10 nm to 1000 nm.

In case the resin optical member 10 is formed by injection molding, the fine asperity structure 20 can be formed by using a mold formed with nano-order fine asperity structure on its surface. The method of forming the fine asperity structure 20 is not limited to the example above and any of various methods may be used. For example, the fine asperity structure 20 may be formed by etching a mold or nanoimprinting a resin optical member.

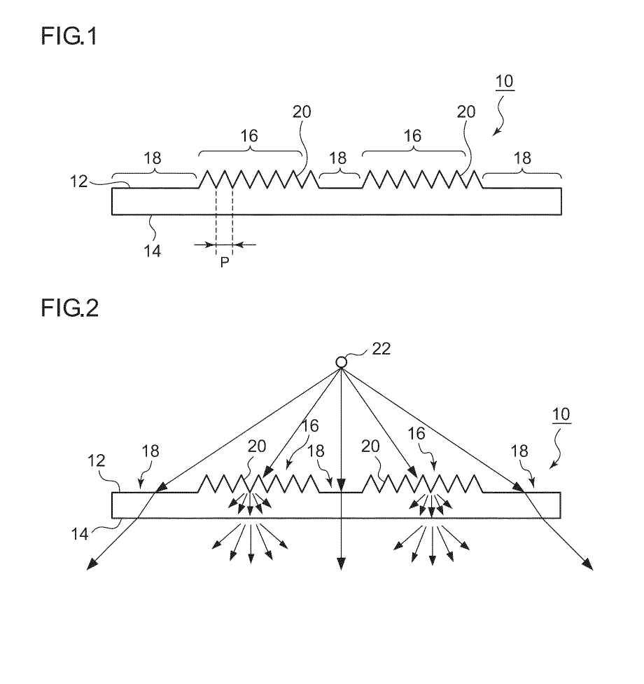

FIG. 2 illustrates the action of the resin optical member 10 according to the embodiment. It is assumed, as shown in FIG. 2, that light from a light source 22 provided above the incident surface 12 is incident on the incident surface 12 of the resin optical member 10. FIG. 2 shows how the light from the light source 22 is incident on the flat portion 18 and the fine asperity structure 20 of the incident surface 12.

As shown in FIG. 2, the light incident on the flat portion 18 is transmitted through the resin optical member 10 and exits from the exit surface 14. Meanwhile, the light incident on the fine asperity portion 16 is scattered by the fine asperity structure 20. The scattered light is transmitted through the resin optical member 10 and exits from the exit surface 14.

The light incident on the fine asperity portion 16 is scattered because nano-scale asperities of the fine asperity portion 16 are recognized by the light as “fine particles”. Generally, collision of light with particles smaller than a wavelength of visible light produces Rayleigh scattering. Since the fine asperity portion 16 according to the embodiment is provided with concavities or convexities at a pitch equal to or less than a wavelength of visible light, the light incident on the fine asperity portion 16 undergoes Rayleigh scattering.

By forming on the incident surface 12 the fine asperity portion 16 formed with the fine asperity structure 20 and the flat portion 18 not formed with fine asperity structure as in the resin optical member 10 according to this embodiment, the way the resin optical member 10 is lighted can be changed depending on the portion of the resin optical member 10. More specifically, the light incident on the flat portion 18 exits from the exit surface 14 as refracting light, but the light incident on the fine asperity portion 16 exits from the exit surface 14 as scattered light. Therefore, the fine asperity portion 16 and the flat portion 18 appear differently as they are lighted. Therefore, the resin optical member 10 according to the embodiment can be used to display a character by designing the fine asperity portion 16 in the shape of a character. Alternatively, a design pattern can be displayed by designing the fine asperity portion 16 in a desired design pattern.

Since the fine asperity structure 20 formed in the fine asperity portion 16 is on the nano-order, the difference between the appearance of the flat portion 18 and the fine asperity structure 20 can hardly be recognized even when the resin optical member 10 is viewed when the light source 22 is turned off. Therefore, the resin optical member 10 according to this embodiment can present an appearance of novel design such that the resin optical member 10 looks transparent when the light source is turned off and, when the light source is turned on, a character or a design pattern emerges from the background.

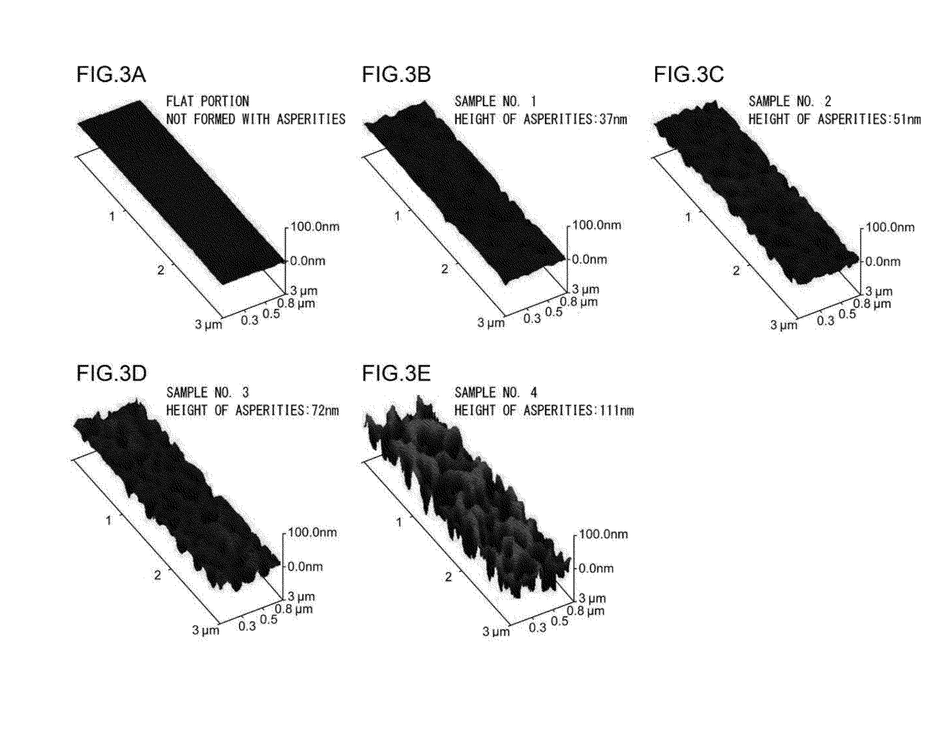

FIGS. 3A-3E show atomic force microscopic (AFM) images of the incident surface 12 of the resin optical member 10.

FIG. 3A shows an AFM image of the flat portion not formed with fine asperity structure by way of comparison. FIG. 3B shows an AFM image of the fine asperity portion in which concavities or convexities have a height 37 nm (Sample No. 1). FIG. 3C shows an AFM image of the fine asperity portion in which concavities or convexities have a height 51 nm (Sample No. 2). FIG. 3D shows an AFM image of the fine asperity portion in which concavities or convexities have a height 72 nm (Sample No. 3). FIG. 3E shows an AFM image of the fine asperity portion in which concavities or convexities have a height 111 nm (Sample No. 4). In Samples No. 1-4, the pitch of concavities or convexities is 200 nm.

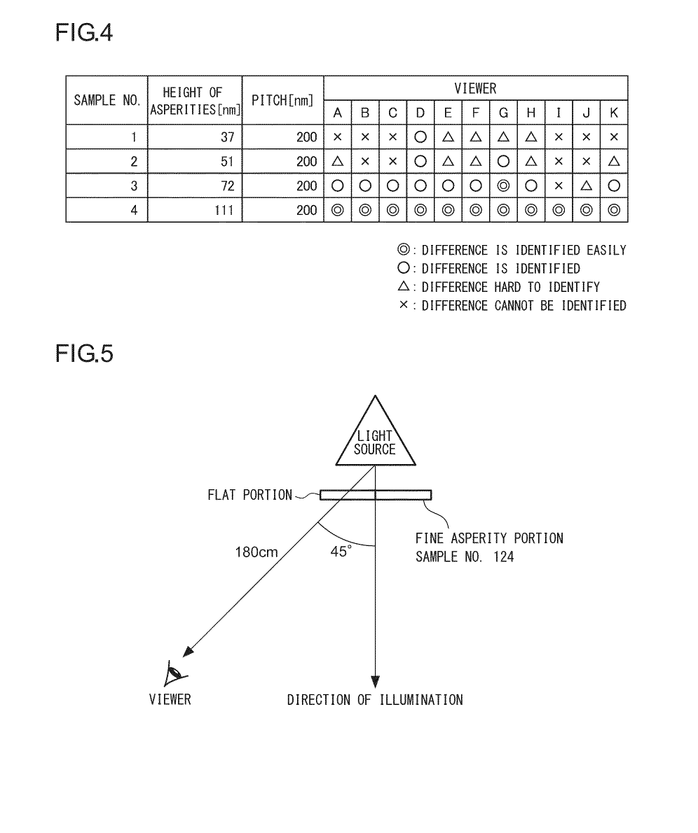

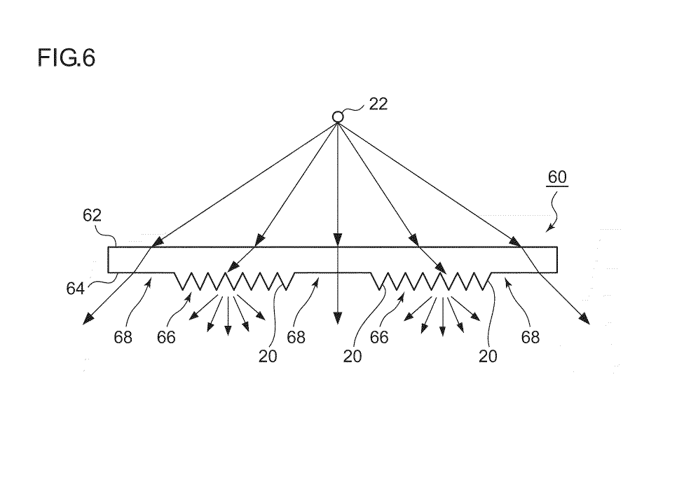

FIG. 4 shows results of experiments to determine whether a viewer can recognize the difference between the fine asperity portion of Sample Nos. 1-4 and the flat portion. FIG. 5 shows conditions in which the experiments were conducted. As shown in FIG. 6, the flat portion and the fine asperity portion are arranged in front of a light source and are viewed at an angle of 45° with respect to the direction of illumination. The distance from the flat portion and the fine asperity portion to the viewer is 180 cm.

Responses to a question asking whether there is a difference between in appearance between the flat portion and the fine asperity portion were collected from 11 viewers A-K In the experiment results of FIG. 4, double circles indicate responses telling that a difference between the flat portion and the fine asperity portion is identified easily. Circles indicate responses telling that a difference between the flat portion and the fine asperity portion is identified. Triangles indicate responses telling that a difference is hard to identify. Crosses indicate responses telling that a difference cannot be identified.

The experiment results of FIG. 4 reveal that the higher the concavities or convexities, the easier it is to identify a difference between the flat portion and the fine asperity portion. The experiment results of FIG. 4 show that some viewers can at least recognize a difference between the flat portion and the fine asperity portion if the height of concavities or convexities is 37 nm. Meanwhile, it is preferable that the height of concavities or convexities is equal to or less than a wavelength of visible light, i.e., 780 nm or less, in order to produce Rayleigh scattering properly in the fine asperity structure. Therefore, the height of concavities or convexities is preferably between 37 nm and 780 nm, both inclusive, in order to let the viewer to identify a character or a design pattern in the optical resin member according to the embodiment. It is more preferable that the height of concavities or convexities is between 51 nm and 780 nm, both inclusive. In this case, responses telling that a difference between the flat portion and the fine asperity portion is identified were collected from more viewers. It is still more preferable that the height of concavities or convexities is between 72 nm and 780 nm, both inclusive. In this case, responses telling that a difference between the flat portion and the fine asperity portion is identified were collected from most viewers. It is yet more preferable that the height of concavities or convexities is between 111 nm and 780 nm, both inclusive. In this case, responses telling that a difference between the flat portion and the fine asperity portion is identified easily were collected from all viewers.

FIG. 6 shows a resin optical member 60 according to another embodiment of the present invention. In the resin optical member 60 according this embodiment, an incident surface 62 on which light from the light source 22 is incident is flat and is not formed with fine asperity structure. Meanwhile, an exit surface 64 includes a fine asperity portion 66 formed with fine asperity structure 20 and a flat portion 68 not formed with fine asperity structure.

In the resin optical member 60 according to this embodiment, light exiting the fine asperity portion 66 is scattered. Therefore, the fine asperity portion 66 and the flat portion 68 appear differently as they are lighted. Therefore, the resin optical member 60 according to this embodiment can also present an appearance of novel design such that the resin optical member 60 looks transparent when the light source is turned off and, when the light source is turned on, a character or a design pattern emerges from the background.

In the embodiments described above, the incident surface or the exit surface of the resin optical member is provided with a fine asperity portion formed with fine asperity structure and a flat portion not formed with fine asperity structure. Alternatively, both the incident surface and the exit surface of the resin optical member may be provided with a fine asperity portion and a flat portion. The surface provided with a fine asperity portion and a flat portion is not limited so long as it is a surface of a resin optical member that functions optically. “A surface that functions optically” means a surface that optically inputs and outputs light from a light source and reflects or refracts the light. For example, the term does not encompass a surface provided only for the purpose of mounting the resin optical member to a lamp body.

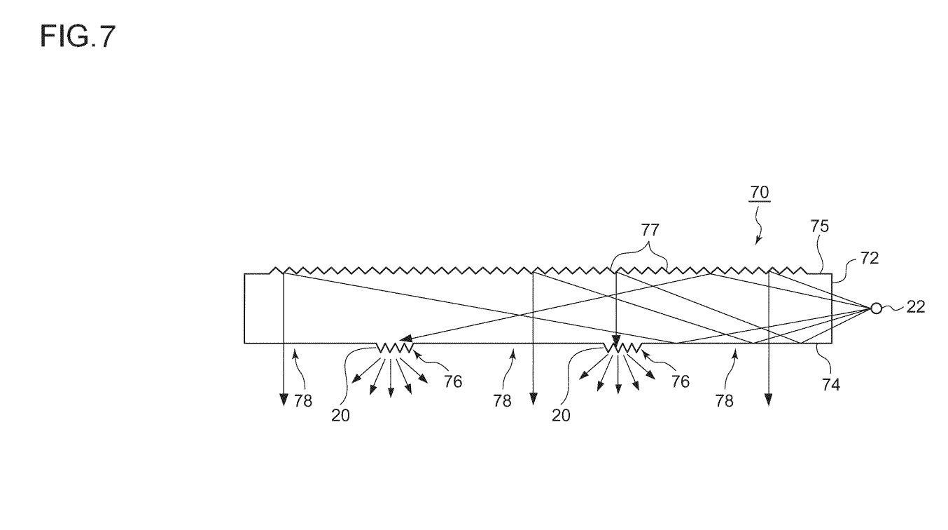

FIG. 7 shows a resin optical member 70 according to still another embodiment of the present invention. The resin optical member 70 according to this embodiment is a rod-shaped light guide used as a light guide for an automotive lamp. The resin optical member 70 is formed by injection molding of a transparent resin such as acryl or polycarbonate. FIG. 7 depicts a straight rod-shaped light guide. The shape is not limited to that of the illustration. The light guide may be of any of various shapes depending on the shape of an automotive lamp in which it is built.

The resin optical member 70 according to this embodiment has a substantially circular cross section, but the shape of the cross section is not limited to a circle. For example, the resin optical member 70 may have a square cross section. One end face of the resin optical member 70 is configured as an incident surface 72 on which light is incident from the light source 22. The circumferential surface of the resin optical member 70 toward the front is configured as an exit surface 74 from which light exits. A rear surface 75 in the circumference of the resin optical member 70 is formed, along the direction of extension of the resin optical member 70, with a plurality of steps 77 that reflect light traveling in the resin optical member 70 toward the exit surface 74. The pitch between the steps 77 is on the order of millimeters. For example, the pitch may be between about 0.5 mm and 2 mm.

The exit surface 74 of the resin optical member 70 according to this embodiment includes a fine asperity portion 76 formed with fine asperity structure 20 and a flat portion 78 not formed with fine asperity structure.

Light exiting the light source 22 enters the resin optical member 70 via the incident surface 72 of the resin optical member 70. The light incident on the resin optical member 70 travels in the resin optical member 70, repeating total reflection. The light incident on the steps 77 provided on the rear surface 75 as the light travels in the resin optical member 70 is reflected by the steps 77 toward the exit surface 74 and exits the resin optical member 70 from the exit surface 74. Reflection occurs similarly in each of the steps 77 provided along the direction of extension of the resin optical member 70 with the result that the light exits substantially from the entire region of the exit surface 74 along the extension of the resin optical member 70.

In the resin optical member 70 according to this embodiment, light exiting the fine asperity portion 76 is scattered. Therefore, the fine asperity portion 76 and the flat portion 78 appear differently as they are lighted.

Therefore, the resin optical member 70 according to this embodiment can also present an appearance of novel design such that the resin optical member 70 looks transparent when the light source is turned off and, when the light source is turned on, a character or a design pattern emerges from the background. A similar advantage is obtained even if the rear surface 75 of the resin optical member 70 is not provided with the plurality of steps 77.

A description will now be given of an exemplary embodiment of an automotive lamp in which the resin optical member described above is used.

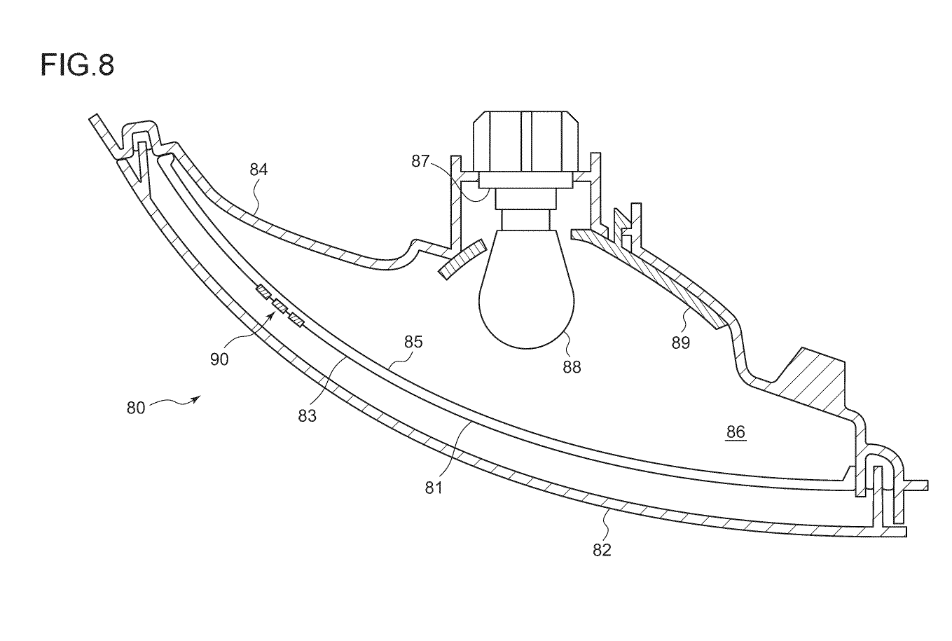

FIG. 8 is a schematic horizontal cross sectional view of an automotive lamp 80 according to the first exemplary embodiment. The automotive lamp 80 according to this exemplary embodiment is used as a tail lamp or a stop lamp provided toward the back of an automobile.

The automotive lamp 80 is provided with a lamp body 84 and a transparent outer lens 82 that covers the front opening of the lamp body 84. The outer lens 82 is formed to be curved from front to side of the lamp. The lamp body 84 and the outer lens 82 define a lamp chamber 86. Inside the lamp chamber 86 are provided a bulb 88 as a light source, a bulb socket 87 as a light source mount, a reflector 89 for reflecting light from the bulb 88, and an inner lens 81 for controlling direct light from the bulb 88 and reflected light from the reflector 89 so as to emit the light toward the outer lens 82. In this exemplary embodiment, the inner lens 81 is provided with a fine asperity portion formed with fine asperity structure and a flat portion not formed with fine asperity structure.

The bulb 88 is supported by the bulb socket 87 mounted to the lamp body 84 and electrically connected to the bulb socket 87. The reflector 89 is disposed to surround the bulb 88 from the rear of the bulb 88 and is supported by the lamp body 84.

The inner lens 81 is formed along the outer lens 82 and is supported by the lamp body 84. An exit surface 83 of the inner lens 81 (the surface toward the outer lens 82) is spaced apart from the outer lens 82 by a certain distance. An incident surface 85 (the surface toward the bulb 88) of the inner lens 81 is formed with a plurality of steps (not shown) for controlling direct light from the bulb 88 and reflected light from the reflector 89. The plurality of steps may be a plurality of fish-eye steps arranged in a grid.

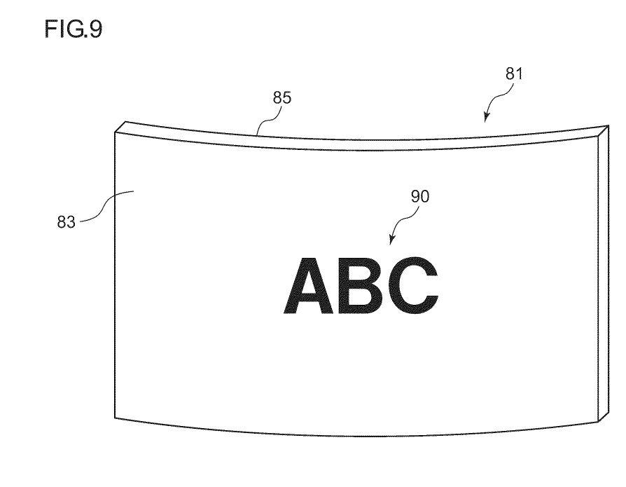

FIG. 9 shows a part of the side of inner lens 81. As shown in FIG. 9, the exit surface 83 of the side of the inner lens 81 is inscribed with a character 90 “ABC”. The character 90 “ABC” is drawn by forming fine asperity structure in the shape of the character “ABC” on the exit surface 83. In other words, the character 90 represents the fine asperity portion surrounded by the flat portion.

In the automotive lamp 80 according to this embodiment, it impossible or at least not easy to identify the character 90 “ABC” even if the inner lens 81 is inspected visually when the bulb 88 is turned off. Meanwhile, when the bulb 88 is turned on, the character 90 “ABC” appears differently from the portion around as it is lighted due to the scattered light and so becomes visible. Thus, the automotive lamp 80 according to this embodiment can present an appearance of novel design such that the character 90 emerges on the inner lens 81 when the bulb 88 is turned on.

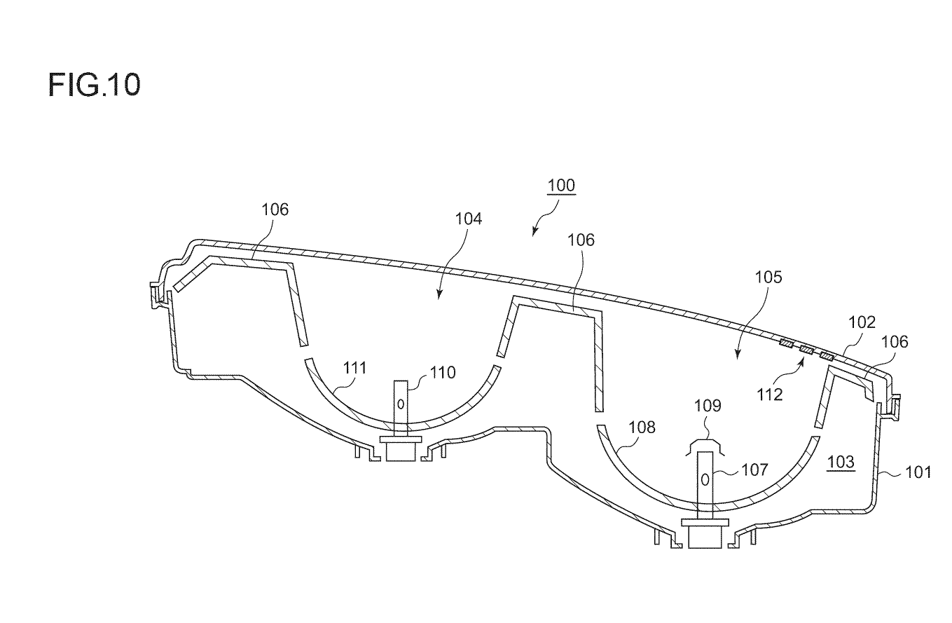

FIG. 10 is a schematic horizontal cross sectional view of an automotive lamp 100 according to the second exemplary embodiment. The automotive lamp 100 according to this exemplary embodiment is used as automotive headlamps provided across the width of a vehicle, one on the left side and the other on the right side.

As shown in FIG. 10, the automotive lamp 100 is configured such that a high beam lamp unit 104 and a low beam lamp unit 105 are accommodated in a lamp chamber 103 formed by a lamp body 101 and a front cover 102 mounted to the front opening of the lamp body 101. In this exemplary embodiment, the front cover 102 is provided with a fine asperity portion formed with fine asperity structure and a flat portion not formed with fine asperity structure.

Each lamp unit is mounted to the lamp body 101 by a support member (not shown). An extension member 106 having an opening where the lamp is located is fixed to the lamp body 101 or the front cover 102, shielding a region between the front opening of the lamp body 101 and the lamp from front view.

The low beam lamp unit 105 is a lamp unit of reflective type well known in the related art and includes a bulb 107 and a reflector 108. The reflector 108 of the low beam lamp unit 105 reflects light emitted from the bulb 107. A light shielding plate (not shown) cuts a portion of light traveling forward from the reflector 108 so as to form a low beam light distribution pattern having a predetermined cutoff line. A shade 109 for cutting the light emitted forward directly from the bulb 107 is provided at the end of the bulb 107. The configuration of the low beam lamp unit is not limited to the configuration described above.

The high beam lamp unit 104 is also a lamp unit of reflective type and includes a bulb 110 and a reflector 111. The reflector 111 of the high beam lamp unit 104 reflects light emitted from the bulb 110 so as to form a high beam light distribution pattern. The configuration of the high beam lamp unit is not limited to the configuration described above.

As shown in FIG. 10, the inner surface of the front cover 102 of the automotive lamp 100 according to this exemplary embodiment is inscribed with a character 112. The character 112 is drawn by forming fine asperity structure in the shape of the character on the inner surface of the front cover 102. In other words, the character 112 represents the fine asperity portion surrounded by the flat portion.

In the automotive lamp 100 according to this embodiment, it impossible or at least not easy to identify the character 112 even if the front cover 102 is inspected visually when the bulb 107 is turned off. Meanwhile, when the bulb 107 is turned on, the character 112 appears differently from the portion around as it is lighted due to the scattered light and so becomes visible. Thus, the automotive lamp 100 according to this embodiment can present an appearance of novel design such that the character 112 emerges on the front cover 102 when the bulb 107 is turned on.

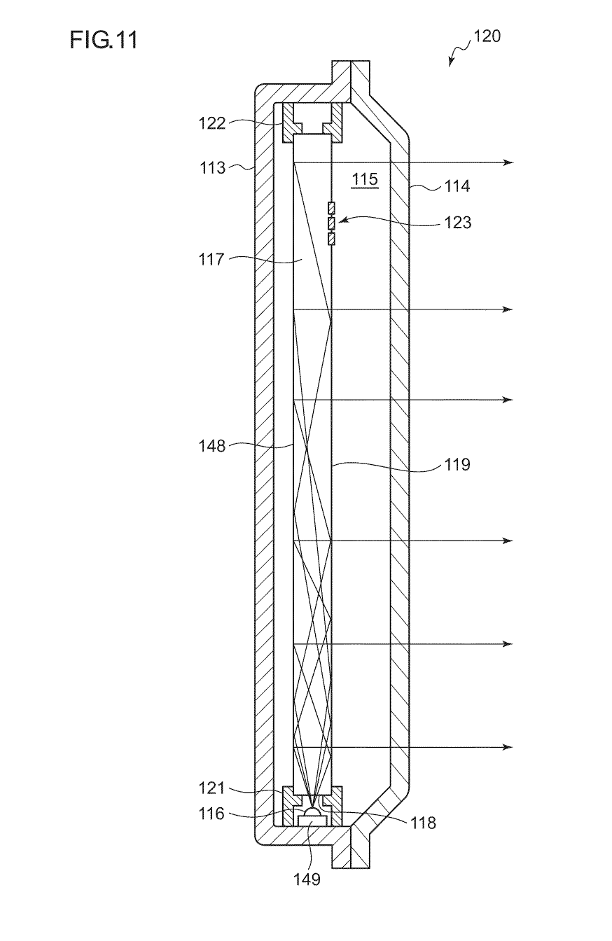

FIG. 11 is a schematic horizontal cross sectional view of an automotive lamp 100 according to the third exemplary embodiment. The automotive lamp 120 according to this exemplary embodiment can be used as a tail lamp or a stop lamp provided toward the back of the automobile.

The automotive lamp 120 is provided with a lamp body 113 and a transparent front cover 114 that covers the opening in front of the lamp body 113. The lamp body 113 and the front cover 114 define a lamp chamber 115. An LED 116 and a light guide 117 are provided in the lamp chamber 115. The LED 116 is mounted on a light source mount 149 fixed to the lateral surface of the lamp body 113 so as to face an incident surface 118 of the light guide 117.

As illustrated in detail in FIG. 7, the light guide 117 guides light incident on the incident surface 118 so as to exit from an exit surface 119. A rear surface 148 opposite to the exit surface 119 is provided with a plurality of steps (not shown) for reflecting the light traveling in the light guide 117 toward the exit surface 119, in the direction of extension of the light guide 117. The light guide 117 is secured and supported by support members 121 and 122 fixed to the respective lateral surfaces of the lamp body 113.

As shown in FIG. 11, the exit surface 119 of the light guide 117 of the automotive lamp 120 according to this embodiment is inscribed with a character 123. The character 123 is drawn by forming fine asperity structure in the shape of the character on the exit surface 119 of the incident surface 118.

In other words, the character 123 represents the fine asperity portion surrounded by the flat portion.

In the automotive lamp 120 according to this embodiment, it impossible or at least not easy to identify the character 123 even if the light guide 117 is inspected visually when the LED 116 is turned off. Meanwhile, when the LED 116 is turned on, the character 123 appears differently from the portion around as it is lighted due to the scattered light and so becomes visible. Thus, the automotive lamp 120 according to this embodiment can present an appearance of novel design such that the character 123 emerges on the light guide 117 when the LED 116 is turned on.

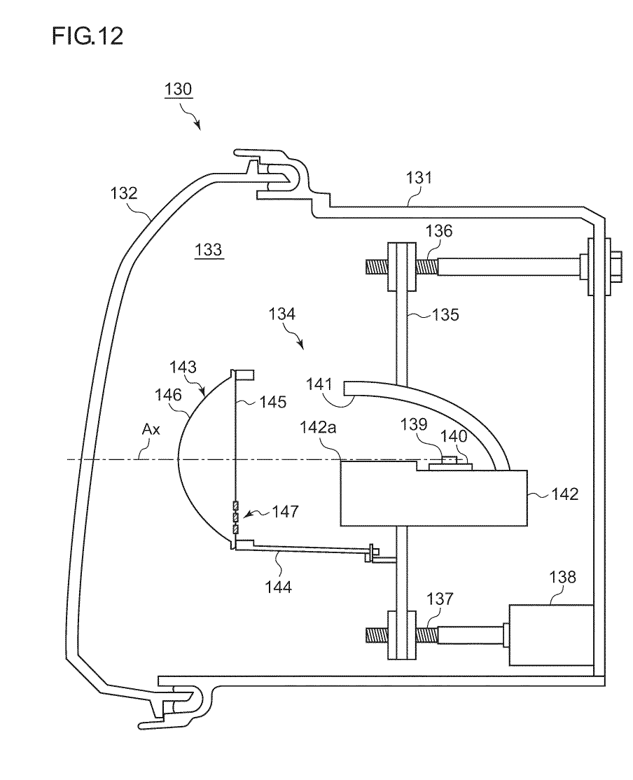

FIG. 12 is a schematic vertical cross sectional view of an automotive lamp 130 according to the fourth exemplary embodiment. The automotive lamp 130 is of projector type and has a function of emitting a low beam ahead a vehicle.

As shown in FIG. 12, the automotive lamp 130 is provided with a lamp body 131 having a recess that opens in front of the lamp, and a front cover 132 that covers the opening the lamp body 131. An interior space formed by the lamp body 131 and the front cover 132 is defined as a lamp chamber 133.

A lamp unit 134 is provided in the lamp chamber 133. As shown in FIG. 12, the lamp unit 134 is mounted substantially at the center of a bracket 135. A first aiming screw 136 is tightened to the top of the bracket 135, and a second aiming screw 137 is tightened to the bottom of the bracket 135. The bracket 135 is supported by the first aiming screw 136 and the second aiming screw 137 such that the bracket 135 can be tilted as desired with respect to the lamp body 131. An aiming actuator 138 is provided in the lower, second aiming screw 137. When the aiming actuator 138 is driven, the lamp unit 134 is tilted in association with the tilt of the bracket 135, thereby adjusting the light axis of illumination light (aiming adjustment).

The lamp unit 134 is provided with an LED 139 as a light source, a substrate 140 as a light source mount, a reflector 141 for reflecting light from the LED 139 ahead of the lamp, a substrate support member 142 for supporting the substrate 140, a projection lens 143, and a lens support member 144.

The reflector 141 has a substantially elliptical vertical cross section and a horizontal cross section configured as an ellipse-based free-form surface. The reflector 141 is arranged such that the first focal point is located near a light emitting portion of the LED 139, and the second focal point is located near an end 142a of the substrate support member 142. The end 142a of the substrate support member 142 is configured to selectively cut the light reflected from the reflector 141 and form an oblique cutoff line in a light distribution pattern projected ahead of the vehicle. In other words, the end 142a of the substrate support member 142 functions as a shade that shields a portion of the light from the reflector.

The projection lens 143 is provided with an incident surface 145 on which the light emitted by the LED 139 and then reflected by the reflector 141 is incident, and an exit surface 146 from which the light is directed ahead of the lamp. The projection lens 143 is a plano-convex aspherical lens in which the incident surface 145 is formed to be planar and the exit surface 146 is formed to be convex. The projection lens 143 is supported by the lens support member 144 and provided in front of the reflector 141. A light axis Ax of the projection lens 143 is substantially parallel to the longitudinal direction of the vehicle. Further, the back focal point of the projection lens 143 substantially coincides with the second focal point of the reflector 141. The projection lens 143 inverts an image of the light source formed on the back focal plane and projects the inverted image ahead of the automotive lamp 130.

As shown in FIG. 12, the incident surface 145 of the projection lens 143 of the automotive lamp 130 according to this exemplary embodiment is inscribed with a character 147. The character 147 is drawn by forming fine asperity structure in the shape of the character on the incident surface 145. In other words, the character 147 represents the fine asperity portion surrounded by the flat portion.

In the automotive lamp 130 according to this embodiment, it impossible or at least not easy to identify the character 147 even if the projection lens 143 is inspected visually when the LED 139 is turned off. Meanwhile, when the LED 139 is turned on, the character 147 appears differently from the portion around as it is lighted due to the scattered light and so becomes visible. Thus, the automotive lamp 130 according to this exemplary embodiment can present an appearance of novel design such that the character 147 emerges on the projection lens 143 when the LED 139 is turned on.

In the exemplary embodiments described above, the character is displayed by forming fine asperity structure in the shape of the character. Alternatively, fine asperity structure may be formed around a character and the character portion is formed to be flat. This can also ensure that the character portion appears differently from the portion around as it is lighted so that the character emerges from the background when the light source is turned on. In the exemplary embodiments described above, characters are shown as examples of a target of display. However, the target of display is not limited to characters. For example, a design pattern may be displayed.

In the exemplary embodiments described above, scattered light is produced by fine asperity structure. Meanwhile, fine asperity structure do not reflect light so much. Therefore, the amount of light transmitted is not substantially decreased as compared with the flat portion. Therefore, formation of fine asperity structure on a surface essential for light distribution does not result in a disadvantage such as insufficient amount of light and so does not affect light distribution. In other words, the surface used for light distribution may be formed with fine asperity structure.

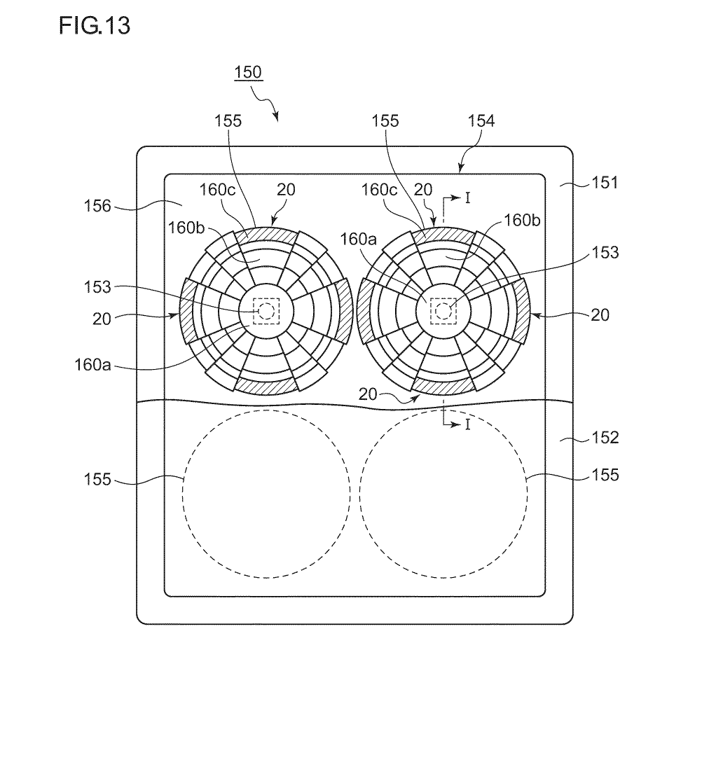

FIG. 13 is an exploded front view of an automotive lamp 150 according to the fifth exemplary embodiment. The automotive lamp 150 shown in FIG. 13 is used as a tail lamp or a stop lamp toward the back of the automobile. The automotive lamp 150 may be built in a rear combination lamp including a backup lamp, a turn signal lamp, etc.

The automotive lamp 150 is built in a lamp chamber formed by a lamp body 151 and an outer lens 152 mounted to the front opening of the lamp body 151, the lamp body 151 having a shape of a rectangular container.

The automotive lamp 150 is formed by a circuit substrate 156 on which four LED's 153 are mounted in respective cells, and a complex inner lens 154 arranged in front of the circuit substrate 156. The complex inner lens 154 is configured such that four inner lenses 155 corresponding to the four LED's 153 respectively are arranged vertically and horizontally. The complex inner lens 154 is formed by injection molding of a transparent resin such as acryl or polycarbonate.

The automotive lamp 150 is configured to cause light emitted from each of the LED's 153 to be incident on the corresponding inner lens 155 and guide the light in the inner lens 155 by refracting or internally reflecting the light in the inner lens 155, and to emit the light with a desired light distribution pattern. The automotive lamp 150 functions as a tail lamp when the four LED's 153 are lighted with low brightness and functions as a stop lamp when the LED's 153 are lighted with high brightness.

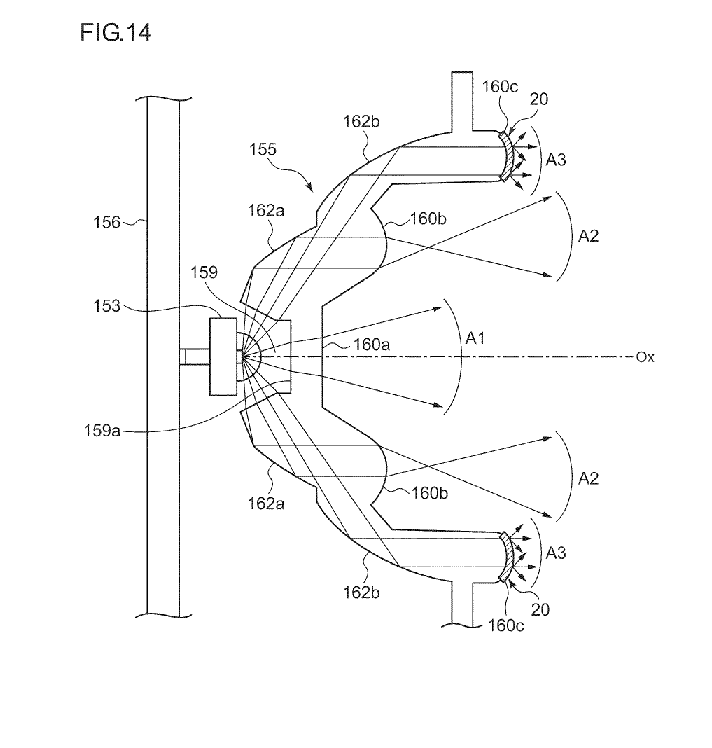

FIG. 14 is a cross sectional view along I-I in FIG. 13 of the inner lens 155 including the LED 153. As shown in FIG. 14, the inner lens 155 is substantially formed to have a shape of a cup. The central axis of the inner lens 155 defines a light axis Ox of the automotive lamp 150 and coincides with the light axis of the LED 153. A light guide recess 159 is formed on the bottom of the inner lens 155. The LED 153 on the circuit substrate 156 is placed in the light guide recess 159. The interior surface of the light guide recess 159 defines an incident surface 159a from which the light from the LED 153 enters the inner lens 155.

The front of the inner lens 155 is provided with a circular central exit surface 160a located at the center, a middle exit surface 160b located outside the central exit surface 160a, and a peripheral exit surface 160c located outside the middle exit surface 160b.

The light emitted from the LED 153 in the direction of light axis is incident on the inner lens 155 via the incident surface 159a before being directed ahead of the lamp (indicated by a light axis A1) from the central exit surface 160a. The light emitted from the LED 153 at a relatively large output angle is incident on the inner lens 155 via the incident surface 159a and is reflected by a middle reflective surface 162a formed outside the light guide recess 159 on the back of the inner lens 155 before exiting outside via the middle exit surface 160b (indicated by a light axis A2). The light emitted from the LED 153 at an intermediate output angle enters the inner lens 155 via the incident surface 159a and is reflected by a peripheral reflective surface 162b formed outside the middle reflective surface 162a on the back of the inner lens 155 before exiting outside via the peripheral exit surface 160c (indicated by a light axis A3).

As shown in FIG. 13, each of the middle exit surface 160b and the peripheral exit surface 160c is comprised of a plurality of small segments. Each small segment has a flat or curved surface. In this exemplary embodiment, fine asperity structure 20 are formed in some of the small segments of the peripheral exit surface 160c. In the exemplary embodiment shown in FIG. 13, four discrete small segments of the plurality of small segments of the peripheral exit surface 160c are formed with fine asperity structure 20. The other small segments of the peripheral exit surface 160c are not formed with fine asperity structure and are formed to be flat. Therefore, the inner lens 155 according to this exemplary embodiment is provided with the peripheral exit surface 160c including small segments formed with the fine asperity structure 20 and flat small segments not formed with fine asperity structure.

In the automotive lamp 150 according to this exemplary embodiment, the light exiting the small segments formed with the fine asperity structure 20 are scattered. Meanwhile, the light exiting the flat small segments are refracted light. Therefore, the small segments formed with the fine asperity structure 20 and the flat small segments are both transparent and do not appear differently when the LED 153 is turned off. When the LED 153 is turned on, however, the small segments formed with the fine asperity structure 20 and the flat small segments appear differently as they are lighted. Accordingly, the automotive lamp 150 according to this exemplary embodiment can present an appearance of novel design.

In this exemplary embodiment, the fine asperity structure 20 are formed in some of the small segments of the peripheral exit surface 160c. Additionally or alternatively, fine asperity structure may be formed in some of the small segments of the middle exit surface 160b. Further, the central exit surface 160a may be formed with fine asperity structure in part of in whole.

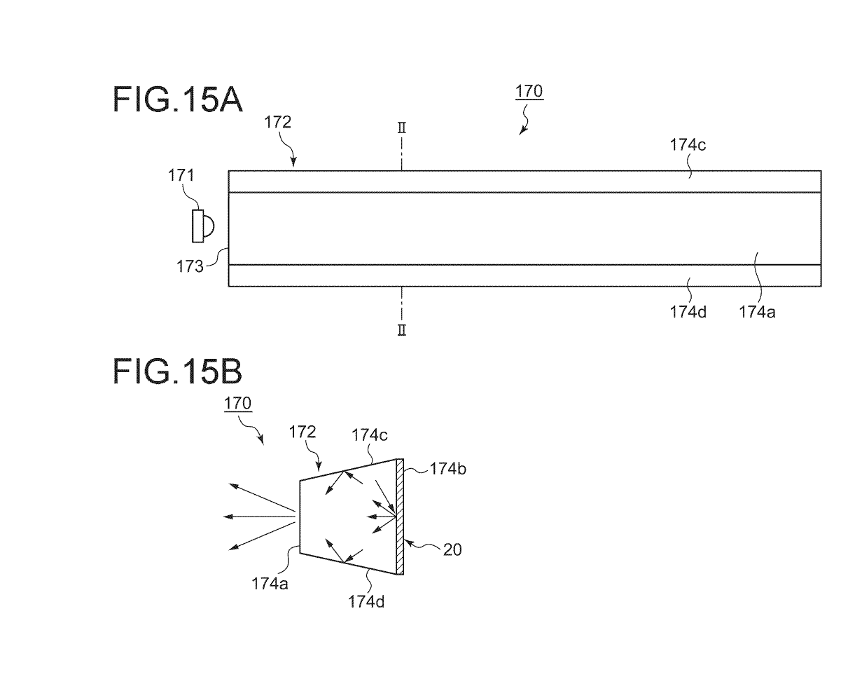

FIGS. 15A and 15B show an automotive lamp 170 according to the sixth exemplary embodiment of the present invention. FIG. 15A is a front view of the automotive lamp 170. FIG. 15B is a II-II cross sectional view of the automotive lamp 170 shown in FIG. 15a. The automotive lamp 170 according to this exemplary embodiment can be used as a tail lamp or a stop lamp provided toward the back of the automobile.

The automotive lamp 170 is provided with an LED 171 and a rod-shaped light guide 172 within a lamp chamber formed by a lamp body and a front cover (not shown). The light guide 172 is formed by injection molding of a transparent resin such as acryl or polycarbonate.

As shown in FIG. 15B, the cross section of the light guide 172 according to this exemplary embodiment is trapezoidal. One end face of the light guide 172 is configured as an incident surface 173 on which light is incident from the LED 171. Of the four lateral surfaces the light guide 172 having the shape of a column with a trapezoidal cross section, an upper base surface 174a is defined as an exit surface from which light exits. The other three lateral surfaces (a lower base surface 174b, leg surfaces 174c and 174d) are formed with a plurality of steps for reflecting the light traveling in the light guide 172 toward the upper base surface 174a (exit surface). In other words, the lower base surface 174b, and the leg surfaces 174c and 174d function as reflective surfaces.

Of the three lateral surfaces of the automotive lamp 170 according to this exemplary embodiment that function as reflective surfaces, the fine asperity structure 20 are formed on the lower base surface 174b. The leg surfaces 174c and 174d are not formed with fine asperity structure and are formed to be flat. Accordingly, the light guide 172 according to this exemplary embodiment is provided with reflective surfaces which include the lower base surface 174b formed with the fine asperity structure 20 and the flat leg surfaces 174c and 174d not formed with fine asperity structure.

In the automotive lamp 170 according to this exemplary embodiment, the light reflected by the lower base surface 174b formed with the fine asperity structure 20 is scattered. Meanwhile, the light reflected by the flat leg surfaces 174c and 174d is not scattered. Therefore, the lower base surface 174b formed with the fine asperity structure 20 and the flat leg surfaces 174c and 174d are both transparent and do not appear differently when the LED 171 is turned off. When the LED 171 is turned on, however, the lower base surface 174b formed with the fine asperity structure 20 and the leg surfaces 174c and 174d appear differently as they are lighted. Accordingly, the automotive lamp 170 according to this exemplary embodiment can present an appearance of novel design.

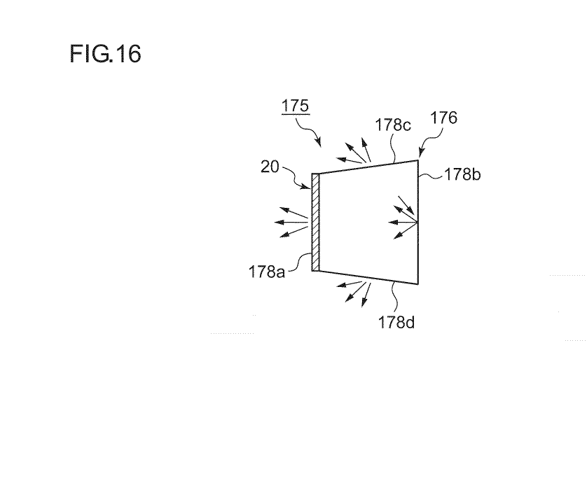

FIG. 16 shows an automotive lamp 175 according to the seventh exemplary embodiment. Like the automotive lamp 170 according to the sixth exemplary embodiment, the automotive lamp 175 according to this exemplary embodiment is provided with a light guide 176 having the shape of a column with a trapezoidal cross section. One end face of the light guide 176 is configured as an incident surface on which light is incident from an LED (not shown). Of the four lateral surfaces the light guide 176 having the shape of a column with a trapezoidal cross section, only a lower base surface 178b is configured to be reflective. The other lateral surfaces (an upper base surface 178a, leg surfaces 178c and 178d) are configured as exit surfaces from which light exits outside. The lower base surface 178b is formed with a plurality of steps for reflecting the light traveling in the light guide 176 toward the exit surfaces, i.e., the upper base surface 178a and the leg surfaces 178c and 178d.

Of the three lateral surfaces of the automotive lamp 175 according to this exemplary embodiment that function as an exit surface, the upper base surface 178a is formed with the fine asperity structure 20. The other exit surfaces, i.e., the leg surfaces 178c and 178d, are not formed with fine asperity structure and are formed to be flat. Accordingly, the light guide 176 according to this exemplary embodiment is provided with exit surfaces including the upper base surface 178a formed with the fine asperity structure 20 and the flat leg surfaces 178c and 178d not formed with fine asperity structure.

In the automotive lamp 175 according to this exemplary embodiment, the light exiting the upper base surface 178a formed with the fine asperity structure 20 is scattered. Meanwhile, the light exiting the flat leg surfaces 178c and 178d is not scattered. Therefore, the upper base surface 178a formed with the fine asperity structure 20 and the flat leg surfaces 178c and 178d are both transparent and do not appear differently when the LED 171 is turned off. When the LED is turned on, however, the upper base surface 178a formed with the fine asperity structure 20 and the flat leg surfaces 178c and 178d appear differently. Accordingly, the automotive lamp 175 according to this exemplary embodiment can present an appearance of novel design.

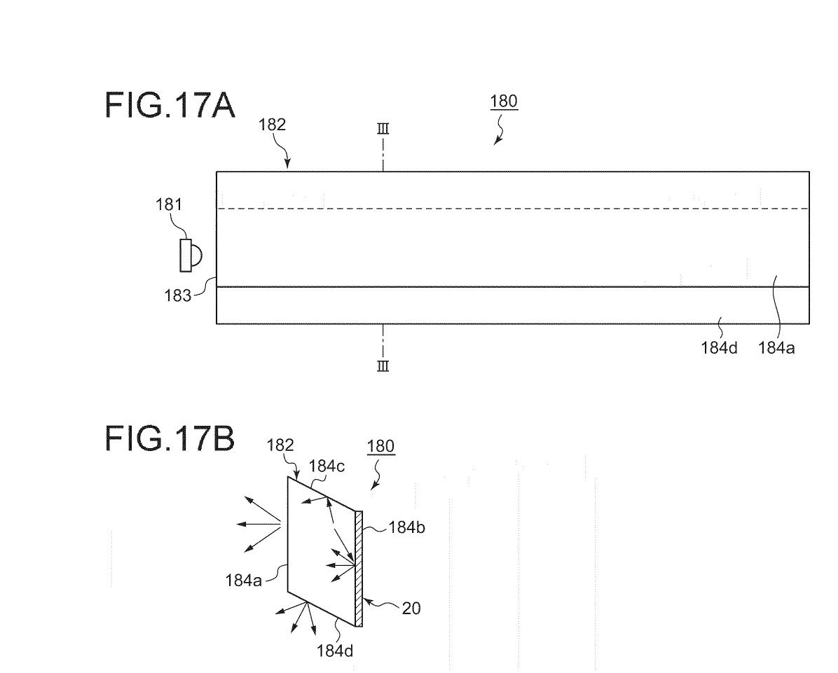

FIGS. 17A and 17B show an automotive lamp 180 according to the eight exemplary embodiment. FIG. 17A is a front view of the automotive lamp 180. FIG. 17B is a III-III cross sectional view of the automotive lamp 180 shown in FIG. 17A. The automotive lamp 180 according to this exemplary embodiment can be used as a tail lamp or a stop lamp provided toward the back of the automobile.

The automotive lamp 180 is provided with an LED 181 and a rod-shaped light guide 182 within a lamp chamber formed by a lamp body and a front cover (not shown). The light guide 182 is formed by injection molding of a transparent resin such as acryl or polycarbonate.

As shown in FIG. 17B, the light guide 182 according to this exemplary embodiment has a parallelogram cross section. One end face of the light guide 182 is configured as an incident surface 183 on which light is incident from an LED 181. Of the four lateral surfaces of the light guide 182 having a parallelogram cross section, a first lateral surface 184a located in front and a fourth lateral surface 184 are configured as exit surfaces from which light exits. The first lateral surface 184a and the fourth lateral surface 184d can be viewed from front when the automotive lamp 180 is mounted on a vehicle. The other two lateral surfaces located toward the back (a second lateral surface 184b and a third lateral surface 184c) are formed with a plurality of steps for reflecting the light traveling in the light guide 182 toward the exit surfaces, i.e., the first lateral surface 184a and the fourth lateral surface 184d. In other words, the second lateral surface 184b and the third lateral surface 184c function as reflective surfaces. The second lateral surface 184b and the third lateral surface 184c cannot be viewed from front when the automotive lamp 180 is mounted on a vehicle.

Of the two lateral surfaces of the automotive lamp 180 according to this exemplary embodiment that function as an exit surface, the second lateral surface 184b is formed with the fine asperity structure 20, and the third lateral surface 184c is not formed with fine asperity structure and is formed to be flat. Accordingly, the light guide 182 according to this exemplary embodiment is provided with reflective surfaces including the second lateral surface 184b formed with the fine asperity structure 20 and the flat third lateral surface 184c not formed with fine asperity structure.

In the automotive lamp 180 according to this exemplary embodiment, the light reflected by the second lateral surface 184b formed with the fine asperity structure 20 is scattered. Meanwhile, the light reflected by the third lateral surface 184c is not scattered. Therefore, the fourth lateral surface 184d formed with the fine asperity structure 20 and the flat third lateral surface 184c are both transparent and do not appear differently when the LED 181 is turned off. When the LED 181 is turned on, however, the fourth lateral surface 184d formed with the fine asperity structure 20 and the flat third lateral surface 184c appear differently. Accordingly, the automotive lamp 180 according to this exemplary embodiment can present an appearance of novel design.

Described above is an explanation based on an exemplary embodiment. The embodiment is intended to be illustrative only and it will be obvious to those skilled in the art that various modifications to constituting elements and processes could be developed and that such modifications are also within the scope of the present invention.

In the exemplary embodiments, the resin optical member according to the embodiment is described as being applied to automotive lamps. Alternatively, the resin optical member can be applied to various electronic devices such as mobile phones.

What is claimed is:

1. A resin optical member that allows light to pass therethrough, comprising a first portion formed with fine asperity structure and a second portion not formed with fine asperity structure.

2. The resin optical member according to claim 1, wherein the fine asperity structure include concavities or convexities formed at a pitch equal to or less than a wavelength of visible light.

3. The resin optical member according to claim 1, wherein the fine asperity structure include concavities or convexities having a height 37 nm or more.

4. An automotive lamp comprising:
a light source mount for mounting a light source; and
a resin optical member that controls light from the light source and directs the light forward, wherein
the resin optical member includes a first portion formed with fine asperity structure and a second portion not formed with fine asperity structure.

5. The automotive lamp according to claim 4, wherein
the resin optical member is a front cover, a projection lens, an inner lens, or a light guide.
